(19) United States
(12) Patent Application Publication
(10) Pub. No.: US 2012/0289156 A1
(43) Pub. Date: Nov. 15, 2012

(54) Multiple uses of an e-book reader

(76) Inventor: Wesley Boudville, Perth (AU)

(21) Appl. No.: 13/068,559

(22) Filed: May 9, 2011

(51) Int. Cl. H04B 7/00; G06F 17/28

(52) U.S. Cl. 455/41.2; 704/3

(57) ABSTRACT

An e-book reader aids in the translation and display of a query. The translation is done by an external website. Another use is for a website to make a customised electronic tourist guide downloadable to the reader, based on an itinerary provided by the user. Also, a reader and cellphone can be interlinked, so photos taken by the latter can be viewed and stored on the reader. Audio conversations and data from sensors associated with the cellphone can also be stored on the reader. The reader's keyboard might be used as the cellphone's keyboard. A reader can extend the scope of using mobile tags and virtual tags for locations where Internet access is lacking.

### REFERENCES CITED

“Web Service Essentials” by E. Cerami, O'Reilly 2002, 0596002246.

“The DHCP Handbook” by R. Droms and T. Lemon, Sams 2002, 0672-323273.

“Javascript: The Definitive Guide” by D. Flanagan, O'Reilly 2006, 978-0596101992.

“Wi-Fi Hot Spots” by E. Geier, Cisco 2006, 978-1587052668.

“Computer Graphics” by J. Foley et al, Addison-Wesley 1990, 0201121107.

“Learning Machine Translation” by C. Goutte et al, MIT Press 2009, 978-0262072977.

“Computer and Communication Networks” by N. Mir, Prentice-Hall 2007, 978-0131389106.

“Interconnecting Smart Objects with IP” by J-P. Vasseur and A. Dunkels, Morgan Kaufmann 2010, 978-0123751652.

“Mobile Intelligence” by L. Yang et al, Wiley 2010, 978-0470195550.

“Mobile device having human language translation capability with positional feedback” by M. Lee et al, US Patent application 20100030549 (2010).

“Method of enabling any-directional translation of selected languages” by W. Drewes, US Patent application 20080177528 (2008).

“Text-to-speech apparatus and method for processing multiple languages” by C. Oh, U.S. Pat. No. 6,141,642 (2000).

“Electronic handheld translator having miniature electronic speech synthesis chip” by Breedlove et al, U.S. Pat. No. 4,631,748 (1986).

[The Web references are as of April 2011.]

adobe.com

amazon.com

bn.com

microsoft.com

openoffice.org

sony.com

wikipedia.org/wiki/Mobile_tagging

wikipedia.org/wiki/Object_hyperlinking

wikipedia.org/wiki/Qr_code

### TECHNICAL FIELD

The invention relates to multiple uses of an electronic book reader.

### BACKGROUND

In recent years, electronic book (“e-book”) readers have become popular. Typically, these offer a screen area for displaying books that is larger than a cellphone's screen, and smaller than a laptop's screen. The attractions include the light weight of the device and the ability to hold many books in electronic format. Another typical feature is wireless capability, via perhaps Wi-Fi or 3G. Though it should be noted that an e-book reader might also have wired capability.

Plus, the reader could have the ability to run a Web browser, and to download and display documents in various formats, including HTML, PDF and plain text.

E-book readers include Amazon Corp.'s Kindle™, Barnes and Noble Corp.'s Nook™ and Sony Corp.'s Digital Book.

### SUMMARY

An e-book reader can aid in the translation and display of a query. The translation is done by an external website, which returns a web page displayable by the reader. The translation could include that of a possible set of replies. The user shows the web page on the reader to a local person who speaks a language different from the user. The choice of target language might be done programmatically, based on the location of the reader and knowledge of the geographic distribution of languages.

The reader can be used as an emergency visual communication device. With the ability to display on and off an image in Morse code fashion, and to display semaphores.

A website can provide a customised electronic tourist guide downloadable to the reader, where the guide is based on an itinerary provided by the user. The guide has much more information than a hardcopy guide. It can include novels based on places in the itinerary, and many photos and accompanying texts taken by independent contributors (crowdsourcing). The guide can be dynamically updated when the user is at a place in the itinerary, with latest information about events at that place.

The guide can show a top level map of a region, showing where photos were taken and their orientations (if such information is available), to help the user in understanding the context of the photos.

The reader and cellphone can be interlinked, so photos taken by the latter can be automatically viewed and stored on the reader, which has more capacity that the cellphone. Other data taken by the cellphone, including audio conversations and data from sensors associated with the cellphone, can also be stored on the reader. The reader's keyboard (real or virtual) might be used as the cellphone's keyboard.

The reader and cellphone can extend the use of mobile codes and virtual tags, where these might be associated with locations lacking (wireless) Internet access.

### BRIEF DESCRIPTION OF THE DRAWINGS

FIG. 1 shows Jane using her e-book reader to communicate with another person, Andre, who speaks a different language than Jane.

FIG. 2 shows a map on the reader of a region around a landmark, with the locations of cameras, where the cameras have taken photos of or around the landmark.

### DETAILED DESCRIPTION OF THE PREFERRED EMBODIMENT

What we claim as new and desire to secure by letters patent is set forth in the following claims.

We define “Reader” to be an e-book reader. The portability of a Reader has led to many people using it in a mobile context, e.g. when at a coffeehouse, or as a passenger in a vehicle. Even when the user is not actually reading the device, she might be carrying it. Extensions of its use are explained.

We use “GPS” to refer to the Global Positioning System and any other satellite navigation system.

This invention is divided into 3 parts. The first is the use of the Reader for multilingual translations. The second is as an electronic tourist guide. The third is the combination of the Reader and a cellphone. The fourth is the combination of the Reader, cellphone and mobile tags.

### 1. Translation

Let Jane be travelling in another country, as a tourist or on business. She is unfamiliar with its language/s. Assume that Jane only knows English. In various situations, she needs to ask information from locals. Suppose that the latter typically do not know English. Define a target language as a native language of the locals. There could be more than one target language, though initially we shall consider only one native language.

In the past, Jane could have used a portable electronic translator. In it, she might type a phrase in English. The device would contain a machine translation (MT) program that would try to translate this into the target language. The output could be text on the device's screen, which Jane would then show to a local. Sometimes the output was Text To Speech (TTS) generated audio. Typically, the device did not have wireless ability. It was entirely self-contained. Also, it would usually be a single function device; it only did translations. Another restriction might be that it could only offer translations to one or a few languages. So if Jane wanted to visit France, she might carry a French device, and if she expected to also visit Germany, she might also need a German device.

Suppose Jane is in France. She wants to ask a question of a local, Andre. Using the Reader of this invention, she wirelessly accesses a website, K. She goes to a web page where she types a question in English. She picks the target language from a menu of supported target languages. This menu's items could be a function of which MT programs K has access to, that translate from English to other languages. When Jane presses return, K processes the page.

K might contact another website, T, that actually runs the appropriate MT. The interaction between K and T could be via Web Services, since this is an interaction between 2 machines. K takes T's translation and formats a web page which is then sent to Jane's Reader.

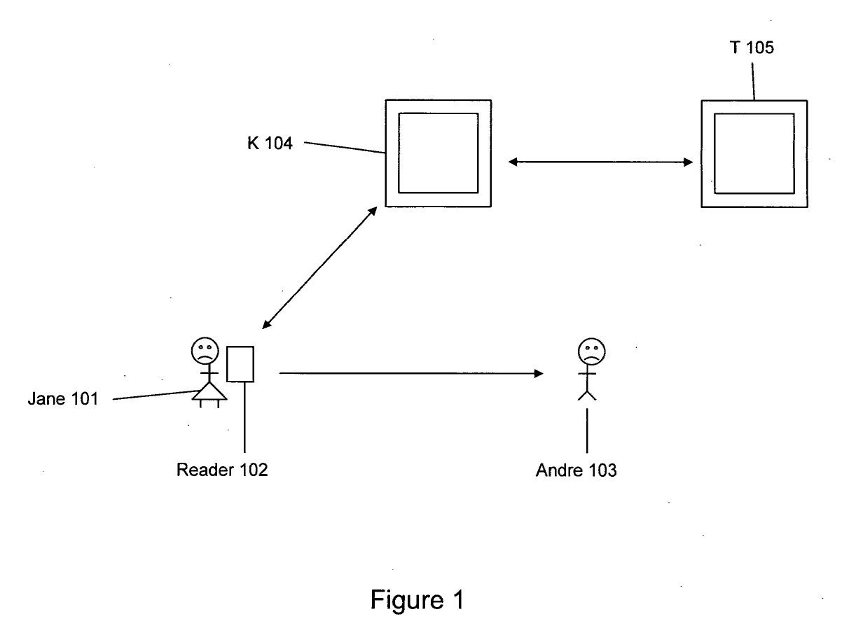

FIG. 1 shows Jane 101, with a Reader 102. Nearby is Andre 103. Reader 102 communicates with K 104, which is on the Internet. K 104 communicates with T 105, which is also on the Internet.

For simplicity, FIG. 1 shows a direct connection between Reader 102 and K 104. In practice, Reader 102 might for example communicate wirelessly via Wi-Fi to a Wi-Fi hot spot that has an Internet connection. This hot spot might assign a temporary Internet Protocol address to Reader 102, perhaps using Dynamic Host Control Protocol (DHCP). Here, the temporary address would be one of several under the control of the hot spot and assigned to it by its upstream Internet provider.

An elaboration of FIG. 1 is where K 104 communicates with several T websites. Where perhaps a given T has an MT program that goes from English to some other specific language, and another T has another MT program that goes from English to another language.

A variant of FIG. 1 is where K 104 could be running the appropriate MT on its own website, so that T 105 is subsumed into K 104.

An extension of the last 2 paragraphs is where K 104 has one or more MT programs running internally, while also accessing other MT programs for other languages, on other websites.

In all these cases, K 104 sends to the Reader a page that shows the question in French. Optionally, the Reader might also display the original question, in English.

Optionally, but preferably, the translated question could be shown in a large font. This takes into account a practical consideration. The Reader has a larger screen than a cellphone. It is easier to show a question that is visible from further away. In general, Andre is a stranger to Jane. Social mores (and maybe even safety aspects) mean that Jane can show her question to Andre without being top close to him.

The decision as to the font size might be influenced by settings that Jane has previously made. Or by K knowing the expected size of the web page when it is shown in the reader. In this case, K might choose a maximal font size, that still allows all of the question (and possible answers) to be shown in the reader.

The displayed page might be in HTML format, or perhaps another format displayable by the Reader. This could include the format used by Microsoft Corp.'s Officep™, or Adobe Corp.'s PDF™ or the format used by OpenOffice.

When Andre reads the question, he might be able to furnish some type of answer, even though he and Jane share no common language. For example, suppose the question is “Does the bus still run at this time?” If the possible answers are the equivalent of “yes” and “no”, then Jane might know the simple translations of those words in French, and hence know Andre's spoken reply. Or from his gestures or nodding, a yes or no could be inferred.

Extensions are possible. Some types of answers to questions could be logically restricted to a few sets of values. For example, {yes, no}, {north, south, east, west}, {left, right}, {forward, back}, {today, tomorrow}. At the earlier step, when Jane was entering her question into a web page provided by T, she might also pick one of these sets of answers. The constructed page sent to the Reader would then have the translated question, and the translated answers.

As a simple user interface issue, the page might have the corresponding English words next to the possible answers; perhaps in a smaller font.

Hence, when Andre reads the Reader, he can point to the appropriate French answer, and Jane can then read off the corresponding English translation.

This is another instance where the Reader with its larger screen is more practical than a cellphone.

For efficiency, the various sets of answers can be precalculated by T and stored in its permanent memory (e.g. disk) and runtime memory (RAM). This reduces the number of real time queries made to an MT program, especially if the latter is another website. Given the capacities of current disks and RAM, the storage requirements are trivial.

Another improvement is where T can offer a series of standard questions in the page that Jane fills out. For example, one such question is “Where is the nearest . . . ”, where this question might then have a menu of choices like {bar, restaurant, hotel, toilet, pharmacy}. Optionally, Jane would be able to type in her own choice, if it is not in that menu. This reduces the amount of typing that she has to do, which makes the process easier and less error prone. Also, the phrases or even the complete questions that correspond to each menu choice can be precalculated in translated form by T.

The concept of standard questions can be carried further. A given question might, depending on the answer, lead to a second question, where the latter might or might not have a standard set of answers. For example, the first question might be “Does this dish have meat?”. If the answer is “yes”, then the second question might be “What type of meat?”, with the possible answers being, for example, {beef, pork, chicken, mutton, duck, fish}. In the context of a restaurant situation, when ordering food, this could be important to Jane, depending on her personal preferences and beliefs. Hence in this example, if Jane is not a vegetarian, but will not eat beef, then the web page that she fills out might have a user interface that lets her select a branch of logic, where she picks the first question, and indicates that if the answer is “yes”, then the second question will be shown.

The specific page that K generates and sends to the reader could be a function of the Reader's capabilities. Suppose the Reader has a touch screen. Then the page might show the first question and the possible answers. If Andre presses “yes”, then the second question and its answers appears. (Here, Andre might be a waiter at a restaurant). Not showing the second question unless it is needed reduces the cognitive burden on Andre. K might query the Reader initially, and get, for example, an XML encoded reply defining the Reader's abilities, where this uses XML tags whose meaning is known to K.

If the reader does not have a touch screen, then both questions and their answers could be shown. And Jane would just manually point to the second question if the answer to the first is “yes”. Or, depending on the abilities of the Reader, only the first question and its answers are shown. If Andre points to “yes”, then Jane might press a button elsewhere on the Reader, or otherwise somehow perform an action on the Reader, that displays the second question and its answers. Where-optionally the first question and its answers could be removed from the screen.

### More Extensions

Above, we indicated that when Jane uses the reader to show the question page on K's website, one of the items that Jane has to pick is the target language. But K can use the Reader's network address and combine this with geospatial information about the geographic distribution of languages to intelligently guess at the target language. It is well known that most IP addresses can be mapped to some geographic region. In general this is considered rudimentary for many geolocation applications, because the location can often only be found to an accuracy of 1 km or so. But for demographic language uses, it is rare to have this fine a resolution in knowledge about the distribution of the users of a language. So the mapping of network address to location is adequate for this invention.

By being able to offer a reasonable guess about the target language, this improves the usability of the invention to Jane.

Thus far, we considered the case of only one target language. But the region that Jane is visiting might have several languages being commonly spoken. In FIG. 1, imagine instead of Jane being in France, that she is in south India, and that in her region, Tamil, Gujurati and Hindi are spoken, in this decreasing order of occurrence. In general, Jane might be unaware of the typical languages in the region she is visiting. But using the location of the Reader, K might have heuristics that recommend to Jane that 3 target languages be used. These could be given in that order of decreasing estimated occurrence. The user interface might let Jane restrict the number of target languages to 2. In this case, she might pick the first 2, as these are more frequent.

Alternatively, Jane might not care about the number of target languages. So K could have logic that defines a maximum number of target languages. If this is greater than 2, then in this example, K would make a web page that has the translated question in those 3 languages; assuming that K can access the appropriate MT programs.

Hence Jane's Reader will show the question in 3 languages, and, if appropriate, 3 sets of default answers.

The above refers to when the Reader is in the foreign location and contacts K wirelessly for the translations. A variant is where Jane, before she travels, uses the Reader to visit K and tells it a list of places and a list of queries (and possibly sets of answers).

Different places might have different lists of queries. In any event, K can use the places to define one or more target languages at each place. Hence, it can make web pages in those languages and send these to the Reader. So that when Jane is in a given place, she can bring up the appropriate web page/s to show locals.

Another extension relates to when an MT for a given source language to target language is unavailable. Suppose perhaps that Jane's source language is Polish and the target language is Tamil. And that no one has written an MT that goes directly between the 2. K might have logic that tries to find one or more {MT}s that can be cascaded to produce the desired output. So, for example, K might search for an MT for Polish to English and an MT for English to Tamil.

But suppose even in this case, no MT path can be found to go from a source to a target language. For the case of standard questions, with optional possible standard answers, the organisation that runs K might have previously hired human translators to manually translate between those 2 languages. These results are then stored in K's permanent storage and made available upon request by Jane. Note that in this case, Jane will not, in general, be able to get questions that are not in the standard set, translated in real time.

Another extension relates to a non-real time determination of questions. Suppose before Jane embarks on her journey, she prepares a set of questions that she expects to need. She can then send these to K, and collect the resultant pages on her Reader. Each page might be stored as a separate document, in a special collection (“folder”). The reader might already have the ability to let her store novels in various folders or categories. She can apply this in the context of this invention.

This has the advantage that she can use these translated questions (and related standard answers if appropriate) even if her Reader is not in contact with the network.

A second advantage is that if we have the situation of 3 paragraphs prior, she can have non-standard questions manually translated in non-real time.

Returning to the real time determination of questions, we consider again the case when there is no MT for source language to target language, even via a cascade of MT. K could have logic that looks for another target language, that might be linguistically close to the original target language, and for which an MT exists for the mapping of source language to this new choice of target language. For example, suppose the original target language is Portuguese. And the source language is Polish. Assume no Polish to Portuguese MT exists. But if a Polish to Spanish MT exists, then K can offer this choice to Jane.

The determination of what languages are close to each other might be done by linguists offline, and encoded in logic used by K.

The ideas in the prior 2 paragraphs relate to languages close to each other in a linguistic sense. Another possibility is where languages are close to each other geographically. Suppose Jane is in Spain, and wants a target language of Basque. If no MT exists for English to Basque, and K finds from Jane's reader location that it is in Spain, K can offer a fallback choice of Spanish as a target language. This assumes that a local that Jane shows her reader output to, will know some Spanish, even if the local's native language is Basque.

Another extension is where suppose Jane has used K's services in the past, in a prior trip. If Jane has a login or account at K, K can maintain a history of Jane's translation requests, and use these to suggest customised questions (and answers) when Jane uses her Reader to access K.

This can be extended by assuming that K does this across many (or all) of its visitors. It can perform analysis and possibly use heuristics to build popular lists of questions (and answers). This can also be correlated with the choices of source and target languages, and also with the regions in which its visitors are in. Thus, frequent questions (and answers) can be translated and cached for the appropriate target languages. And a new visitor, who is in a given region, say, might be presented with a list of possible standard questions, that are based in part on those chosen or requested by previous visitors to K who are in that region.

Hence, over time, the list of standard questions (and answers) and corresponding source and target languages can grow, and be optimised to better serve visitors' needs.

Thus far, when we discussed questions and answers that Jane wants K to translate, both questions and answers were text. A variant is where Jane might want a question to be in graphic form. For example, she might want a photo or drawing of a church or mosque, or of a restaurant or hotel. The intent is that she would display this in the Reader, and then gesture to this in the presence of Andre. She is asking Andre where is the nearest such place.

One reason is to take into account the possibility that Andre is illiterate in his local language. While perhaps if Andre is French, this is unlikely, if Andre is in a developing country, the odds of illiteracy can be much higher.

It is trivial to see that K can have a user interface that lets Jane ask such a request. Then, K can reply with an appropriate image. This can be qualified further by at least 2 choices. The first is for a generic image. The second is for an image of a specific place. For the latter, K can offer a web page that lets Jane define that place, and K can then search its databases for a specific image. Or perhaps search the web.

Suppose Jane just wants a generic image. This can in turn be customised towards the destination region that Jane is in, or plans to go to. K can present a user interface that lets Jane specify this. An example of customised generic images might be of cathedrals in Europe. In Italy, the architecture of a cathedral or large church is in general different from those in northern Europe.

Another set of extensions involves the concept of using the Reader as an emergency visual communication device. All of the previous discussion has been about essentially non-emergency visual use, and where another person (Andre) is nearby. Consider now a scenario where Jane is in an isolated region of the countryside. She wants to summon help, by attracting the attention of a plane or person who is at some distance. Her cellphone, if she has one, is inoperative. Ditto for any satellite phone. She has a Reader.

Imagine that the Reader has active lighting, as opposed to a Reader with a passive screen. So the Reader can be read without external lights. Then suppose that the Reader lets her blink on and off a simple image. The image might be of a filled rectangle, for example. Where the filled portion is lit, and the surrounding part of the screen, if there is any, is unlit. There might be an application on the Reader that lets Jane use a keyboard (either physical or virtual), to type a simple string, and have this translated into Morse code. This is then used to strobe that filled rectangle on and off.

There could be a default string for SOS.

Jane could then hold up the Reader and hope that its signal is seen by an observer.

Why not just have the Reader's screen be turned on to a solid colour? This is possible. But the human visual system is hardwired to detect changes. So having a visual signal that changes is more likely to attract attention.

Another possible way of implementing this method involves the use of K, or of some other external website. A web page might be written, that uses a scripting language (like Javascript) to display an image and periodically turn it on and off. This page, as a file, can be sent to the reader and held for emergencies. It might be activated simply by displaying it in the Reader's screen in a browser, with scripting turned on. This assumes that the Reader's implementation of a web browser is advanced enough to run a common scripting language.

What type of image might be turned on and off? The simplest choice could be a filled rectangle. This might be preferable to a filled circle, because the latter involves more computation; i.e. Bresenham's algorithm for efficiently finding the perimeter of a circle. Computation takes energy. A rectangle is a natural and efficient area to define on the screen.

On the issue of energy optimisation, another aspect could be what type of colours and intensity to show in the filled image. Suppose the screen's pixels are defined by RGB format. White would be the maximal value inn each of those 3 colour channels. But this would drain the battery the fastest. If Jane is trying to attract the attention of a distant observer, there are 2 considerations. The atmosphere attenuates differently at red, green and blue. And the human eye is less sensitive in the red than in green or blue. It may be possible to have an optimal set of values for RGB that are not the maximal values.

A non-emergency variant is simply to have the reader be able to output a Morse coded image, where for ease of use, Jane can type a string in ASCII, and have it output as Morse code in the blinking of an image. This can be where Jane just types a string, and it is then continuously output in a loop as Morse code. Or, Jane types a string, it is output as Morse code, and then, after that is done, she types another string, and that is output as Morse code, etc. This could be implemented as an application, or, if possible, as a web page with the appropriate scripting logic.

In all these usages of Morse code, there might be adjustable parameters that lets Jane control the duration of when the ‘dot’ image is on, the duration of when the ‘dash’ image is on, and the duration of the spacing between two on images.

### 2. Tourist Guide

Consider FIG. 1, where Jane has the Reader contact K before she leaves on her journey. At K, she goes to a web page where she enters her itinerary. Or perhaps on the Reader, she has made a file with this itinerary, which she then uploads to K.

In either case, the itinerary could have a minimum amount of details. Like a list of the places that she plans to visit. If she is typing this into a page at K, then K gets the information in some structured form. While if she has earlier made a file on the Reader, this might have been done in some previously defined structured way; e.g. using an XML format that K is aware of.

The places might be listed in sufficient detail that K's software can uniquely identify them. For example, if ‘Las Vegas’ is listed, then the American state that it is in should also be defined, since this could be Nevada or New Mexico. Or perhaps from the context of the other locations in the itinerary, if the state is omitted, then it might be inferred. For example, if other places are uniquely in Nevada.

K might have code that asks Jane to clarify, whenever there might be ambiguities in location.

At a greater level of detail, the itinerary could also include the days and times of day that Jane plans to be at each place.

Jane might also tell K her interests or hobbies.

K can use this to assemble a customised electronic tourist guide, which is then downloaded to the Reader. A traditional hardcopy guide has severe constraints on the amount of content. The guide needs to be light enough that the owner can carry it around for hours. So maps of a city often only show the main streets and some standard tourist attractions. Plus, for a location shown in a photo, that photo might be the only one for that location in the entire guide. And the narrative text in the guide can only summarise the main attractions in a city. Especially if the guide also has to cover other cities.

But the Reader faces no such constraint. So K can assemble much lengthier narratives of a city or region. It can furnish full maps. It can provide timetables for public transport—bus, train, ferry etc.

Many photos can be used. This is another key advantage over a hardcopy guide. Now, for a given location, e.g. a famous building, there might be several photos of it, taken from all sides. And many more locations in a city can be illustrated. Since for many tourists, the visual attraction of a place might be pre-eminent, then having a guide show images of a multitude of places is a big improvement.

The narratives and photos that K assembles can be from reliable sources. K can also offer these from various websites, blogs etc, where travellers have described their journeys. ‘Crowdsourcing’. Jane might be able to indicate, when she visits K's website, whether she is interested in these.

K might have an arrangement with such a third party website so that it can copy text and images, perhaps by paying a license. This also allows a revenue stream to those websites.

K can also offer Jane various fiction novels, that are set in part in one or more of the places Jane will visit. K might have earlier used various search engines, and perhaps the involvement of an online bookseller, to map between places and novels. For example, suppose an online bookseller lets visitors post reviews of books. The reviews could be scanned, as extra input, alongside the text of the novels themselves, in finding key places in the plots.

In general, if Jane will be travelling, she will typically have much travel time. The providing of novels of her destinations can be attractive, in letting her appreciate some of the local culture and history. This could enhance the sales of such novels.

Now imagine that Jane is on her journey. Suppose the Reader has GPS. When Jane earlier downloaded from K to the Reader, this might have included an application that can use GPS data. In this case,. K might also have provided a mapping from the places to GPS coordinates.

Or, if the Reader does not have GPS, suppose that Jane is carrying another device, like a smartphone, which has GPS. And that the Reader's application can get that GPS data from the device.

The application can now automatically ‘bring forward’ the narratives of a place that Jane is either at, or is approaching in the near future. The latter could be determined by the application accessing the itinerary and knowing the last place on it that was visited, and the current GPS coordinates. Hence, it could present Jane narratives for the next destination.

Suppose the Reader also has access to the Internet. Using knowledge about its current location, or about the next destination, it can download the latest information about the location. Like the weather and current events (sporting, cultural, etc). Hence the travel guide can be dynamic.

The application on the Reader can use any location and orientation information about images to provide a useful top level map. Increasingly, photos taken with a digital camera or cellphone might have geographic coordinates of the photographic device. Possibly also the compass orientation (azimuth) of the device. Optionally, also the elevation of the device lens, and of the altitude (height) of the device. If the altitude is omitted, it might be the default altitude of the ground at the geographic coordinates. Here, by elevation of the lens, we mean the angle at which it is pointed, measured perhaps with 0 degrees being the default where the lens is pointed parallel to the ground, and 90 degrees being pointed vertically upwards. A negative elevation means it is pointed downwards at some angle. For example, if the photographer is at the top of a building and looking down towards the ground. Or if the photographer is at a cliffside, looking down into a canyon.

A photo might also have a timestamp.

Another datum about an image is the extent of its field of view. A wide angle lens might have a 180 degree FOV, for example.

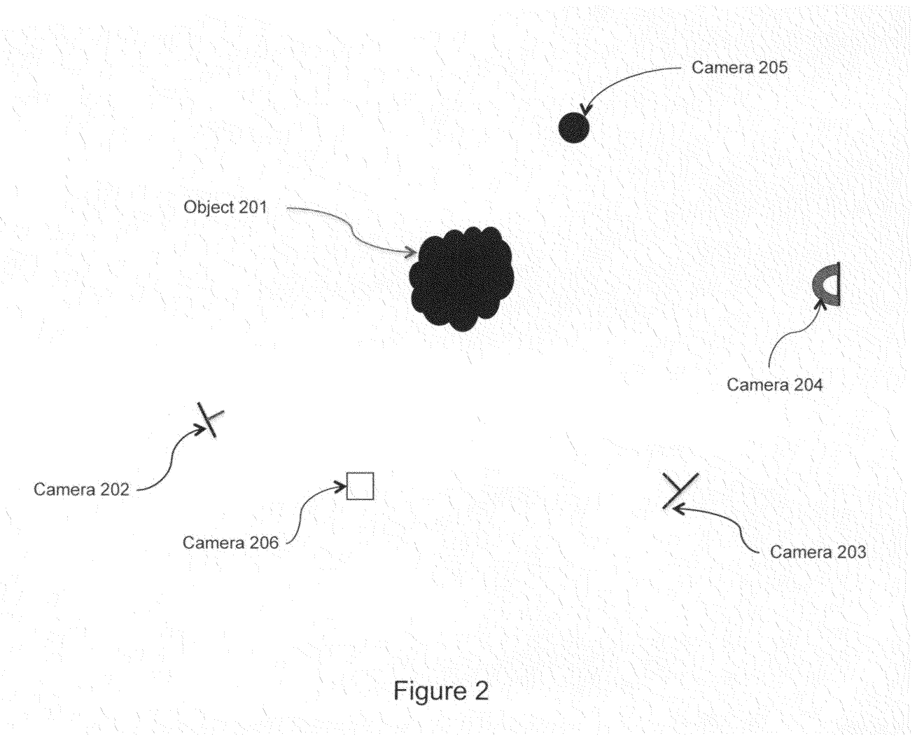

The application can show a map centered on a landmark, where several photos are made available of the landmark. An example is shown in FIG. 2. Object 201 is the landmark. Some schematic symbol represents the landmark. The map might show any nearby roads (not shown in FIG. 2) and other features typically appearing in maps.

But the distinctive aspect of FIG. 2 is the location of cameras from which photos were taken. Camera 202 and Camera 203 show 2 such locations. A symbol of a flat line segment, with a shorter segment 90 degrees to it and at its midpoint is used. The intersection of the 2 segments is the position (latitude, longitude) of the camera. The shorter segment is the orientation (azimuth) of the camera in the horizontal tangent plane.

If the orientation is unknown, then the camera might be depicted as for example Camera 206.

If the camera has a wide angle lens, say 180 degrees, then it could be shown as Camera 204. This assumes that the orientation of the camera is known.

There is also a specialized full 360 degree camera, and it could be shown as Camera 205. Here, the orientation is moot.

While the choices of symbols is arbitrary, the above might be considered intuitive or quickly understandable to an average user like Jane.

Each symbol can be selectable in the Reader. Picking a symbol will show the corresponding underlying image, either replacing the map in the current display region (“window”), or in a new window.

The time information for when the images were taken can be encoded in FIG. 2. Perhaps as colour. (This is not shown in FIG. 2, which is in black and white.) Or, there might an animation, where as time proceeds in it, camera symbols appear in the figure, corresponding to when the images were taken. Here, the symbols can also be optionally colour coded for time.

For legacy photos, for which an accurate location, orientation (etc) might never have been defined, there could be a manual process whereby an approximate location and orientation of each photo is determined. Then the nominal location and orientation could be added to FIG. 2, using a different symbol to designate that this information is perhaps less accurate than the others.

But going forward in time, it can be expected that future photos will be increasingly likely to have a location and timestamp, and possibly orientation and the other metadata.

A novelty of FIG. 2 to Jane is that it shows her more context about where and when photos were taken. Many famous landmarks are often just shown taken from cameras in one location. Granted, this might be deemed the “best” location to view the landmark. And of course a hardcopy tourist guide, being limited in space, would often default to showing only the stereotypical view. But the increasing availability of digital images, and the extra information often encoded with them allows a more comprehensive viewing.

FIG. 2 and the underlying images have another usage. With this information, it might be easier to programmatically construct a three dimensional model of the landmark and its surroundings. The overlaps in the fields of view, and knowledge of the orientations of the images, helps to mathematically define more data for this inverse map. Note that we do not claim that there is necessarily enough information in every case to uniquely define the 3d model. External heuristics and other data might still be needed. But the aggregation of image data can reduce the uncertainty.

This also means that it might be possible to programmatically assign a grade to an image, on the criterion of how much overlap it has with other images. While images might traditionally be graded manually based on aesthetics, here the grade could be largely objective and based in part on mathematics and the ability to contribute to a 3d model.

One extension is that when a selectable symbol is picked in FIG. 2, it shows not just the underlying image, but any associated text. This could have been written by the photographer, or perhaps by others.

The latter case could apply when the image was originally posted on some website, like a blog or social network page, where others commented on it.

Another extension is where Jane can vote and possibly comment on an image. If the Reader is connected to the Internet when Jane does this, her actions can be communicated back to site K, and possibly to the original website where the image appeared. But if the Reader is currently disconnected from the Internet, her actions can be cached on the Reader, and when the Reader is next connected, it can upload that feedback.

This feedback lets K amass ratings on images and possibly on their photographers. Hence, when Jane first asks to see an instance of FIG. 2, one display parameter might be to show only images with votes above some value, or only images from photographers with votes above some value. Or to show some top fraction of ranked images, or images from some top fraction of ranked photographers.

It extends the practice of some online booksellers, that let users write reviews of books on their websites.

An extension relates to the case when the Reader is in contact with the Internet. Suppose the Reader goes to K, or the original website for an image, and uploads Jane's comments and rating of the image (and possibly of any comments associated with that image). If K, or the other website, can find the Reader's approximate location, then it can indicate this, when publishing Jane's comments, to give them added veracity. This is analogous to Amazon Corp.'s practice of indicating that a book review is by a person who has made a “verified purchase” of the book on Amazon. It increases the chance that the reviewer has read the book.

One difference with the latter arises in the accuracy or confidence that K has about the Reader's location. There could be a grading or scale, where the highest grade is when the Reader's location is at or close to that of a camera. While if the Reader's location is known to only 2 kilometer accuracy, say, then a lower grade could be assigned.

Note that a photographer might be a machine or set of machines. Imagine a set of cameras that are deployed in some region, and automatically and perhaps periodically take images, possibly appended with autogenerated text, where these are posted to some website accessible to K.

Consider again FIG. 2. Suppose it would show more cameras near Cameras 202 and 203. So perhaps that area is the preferred one for tourists to see the landmark. When Jane looks at FIG. 2, this can help her decide where to go, around the landmark. She might decide to go where most tourists are going. Alternatively, or in addition, she could decide to visit the location of Camera 205, in part because that location seems relatively unfrequented by visitors. Or for the same reason, she might pick a location that is not near any previous camera.

So the construction of FIG. 2 helps Jane in deciding her possible travel paths. This can be extended by the use of routing algorithms and other map data of the region, that might be stored on the Reader. Jane might ask the Reader for a path between her starting location in that region (a hotel, for example) and, say, Camera 205. This path might be largely restricted to the road network. The path might involve the use of buses or trains, and the use of their timetables.

Or, if the Reader is in contact with the Internet, it might ask a website to define such a path.

Note that this is not about defining any new routing algorithms. In the last 12 years, there has been heavy development of these in the context of the Web, along with the accessibility of road maps. Those websites let a user define arbitrary start and end points. Typically they do not offer reasons why a user should pick a particular destination. This invention aids the user in the latter.

But having said this, there could be another context in which this invention extends the scope of those websites with maps and routing. Often, those are limited to paths using roads or trains. In this invention, paths could include footpaths. So that Jane can navigate on foot near some landmark.

A related context is where the landmark is in a rural area, with only a few roads nearby. Where most of the paths are traversed by foot.

### 3. Reader and Cellphone

Consider now that Jane, who is not necessarily travelling, has a Reader and a cellphone. It is possible to have adaptations of both devices that provide benefits to Jane.

First, note that while both devices can vary in size, depending on the precise models, and also if the cellphone is taken to include the instance of a smartphone, it can be seen that a Reader is about 3 times or more larger than a cellphone. If both devices are made with the same level of electronic device integration, then, approximately, a Reader could have several times the storage capacity of a cellphone, along with having a much larger screen.

Now assume that the cellphone has a camera.

One combination would have the cellphone being able to communicate wired or wirelessly with the Reader, where, when a photo is taken, it is automatically transmitted and displayed on the Reader. Its larger screen will help Jane better evaluate the quality of the image.

If she wishes to retain the image, she has several choices. She can commit it to nonvolatile storage on the Reader. Separately, she can also do this or, perhaps more likely, not do this on the cellphone. The modifications to both devices might let her press a control on just one device, with the relevant actions then occurring on that device and the other relevant commands transmitted to the other device, which acts on them.

When we discuss modifications on each device, these could be separately—a change to the hardware and firmware or operating system on one device, where this is done by the manufacturer; or a third party application or plug-in. One instance of a given choice for one device would interoperate in the manner discussed with either of the choices for the other device.

In some cases, the hardware of a device might be designed to prohibit installation of third party applications (and related hardware). Which would reduce accordingly the possible combinations.

One variation on the above cooperative behaviour is where the image is not shown on the cellphone's screen, to reduce the power consumption.

In the instance of the devices communicating wirelessly, it could be via a line of sight protocol (e.g. infrared) or non-line of sight. For the latter, there might be a choice, possibly default, of doing an encryption and decryption of the data going between the devices.

The above gives Jane 2 advantages over just using the cellphone to take photos. She has a larger screen, and much more storage.

One possible way to implement the interaction between the cellphone and Reader is where both support the Internet Protocol running over the common choice of physical medium used for communication. Then, the Reader could run a Network File Systems server that exports non-volatile storage on the Reader to the cellphone. Here, the storage could be configured as a disk. Where the actual storage on the Reader might be chip memory arranged as a disk simulator or perhaps a physical disk or subset thereof. The cellphone would then import that disk and mount it locally and use it as a local disk for reading and writing. This procedure is well established between 2 desktop systems, and should be straightforward to extend to a cellphone and Reader.

Similarly, the cellphone might export part of its storage to the Reader. Though given that the Reader is expected to have more storage, the arrangement of the previous paragraph might be more common.

A given configuration could have both exports occurring.

Another combination of modifications is the use of an actual keyboard or virtual keyboard on the Reader, in place of the current keyboard equivalent on the cellphone. Typically, a cellphone implements a keyboard in 2 ways. First, by using the digit buttons and mapping each button to several letters. Second, by using a virtual keyboard on the cellphone's screen. A smartphone might do the latter. Both methods are clumsy, slow and error prone. These 3 reasons are not statistically independent.

In contrast, if a Reader has a real keyboard, this can be much easier to use; even if it is smaller than a regular keyboard on a desktop computer. While if the Reader has a virtual keyboard, since this appears on a screen larger than a cellphone's, it can be easier to use; less squinting at the small letters.

If the connection between the cellphone and Reader is non-line of sight wireless, then encryption might be necessary. To prevent someone evesdropping on the interaction, and to prevent someone accidentally or deliberately using his Reader's keyboard to access Jane's cellphone.

Note that for the cases above where signals going between the devices are encrypted, the quantity of information is relatively small. Certainly for key choices. But also for static images going from the cellphone to the Reader. In this case, there are physical constraints on how quickly a cellphone can take a static image. In part due to mechanical limitations on the lens apparatus. Plus, in most usages, Jane will want to review each image on the Reader before possibly storing it. So there is plenty of time for encryption and decryption.

Another combination of modifications is where the digitised conversation between Jane and someone, using her cellphone, is transmitted and stored on the Reader. If the Reader has audio playing ability, then Jane can review her conversations at a later time. The storage on the Reader might include metadata like the phone number of the interlocutor.

Another combination of modifications is where, to the extent possible, the screen of the cellphone (or a subset of it, like a window) is duplicated and possibly magnified on the Reader's screen. This is analogous to how a desktop computer can have multiple screens, with each screen showing the same information. For the current case, duplicating the cellphone screen might let Jane show others what is currently happening on the phone. This is easier than the current common occurrence when two people try to look at the screen of the same cellphone, which can be awkward given its small size.

Having the screen be magnified on the Reader might make it easier for Jane to read it, or for someone to read it.

The duplicate screens also now gives rise to the possibility of a two person interactive game, if the controls of the Reader, or some subset of the controls, can give signals back to an application running on the cellphone, that is controlling a game. An alternative to this is where the game is controlled by the Reader.

If the Reader only has a greyscale display, then when showing colour images, or the cellphone's screen on its screen, there could be default mappings of colours onto corresponding greyscale values.

Some cellphones can show video. A Reader might not be able to do so. Hence if the cellphone's screen or parts thereof are shown on the Reader's screen, then this case would be an exception.

It has been suggested in the technical literature that a cellphone with some type of sensor attached can be used to record data from the sensor, and then upload it wirelessly. In this invention, this can be supplemented by having the cellphone record the sensor data to the Reader. Which is useful when the cellphone is out of range of its network.

But even when the cellphone is in range, recording the data to the Reader could be useful. An analysis application could run on the Reader, that understands the data and can display results.

The Reader might have hardware that can do wired and wireless communication to a cellphone. Here, the wired usage would necessitate some type of plug on the Reader to which a cable from the cellphone is attached. Being able to handle wired and wireless could let the Reader interoperate with different models of cellphones.

The Reader might be able to do only one of the wired and wireless communication at the same time. An extension is where the Reader can do both simultaneously. This would allow the hooking up of 2 cellphones to the Reader. Perhaps for a 3 person interactive game.

An alternative is where the Reader can connect simultaneously to a cellphone and another Reader.

Consider a wired connection between the Reader and a cellphone. We suggested using the Internet Protocol between them. But this was originally developed for a connection that had several (>2) machines, so that collisions could arise. With only two entities on the wire, a simpler and possibly protocol might be used.

### 4. Reader and Cellphone and Mobile Tags

Imagine Jane has a cellphone and the Reader. Before she travels, she is in a location where the Reader has Internet access. She uses it to go to a website M. She gives the coordinates or name of the place she will visit. The giving is to a document on the Reader, which the Reader then uploads to M, or Jane enters the data directly on M. If the giving is as a name or names, it is assumed that this is sufficiently unambiguous for M to determine the place.

This might be done for several places in an itinerary which Jane uploads to M. The itinerary might optionally be in a special format easily programmatically understandable by M. Possibly Jane will indicate those places where there is no cellphone network.

Jane might indicate by the name of each place in the itinerary, or instead as a default, all the places, that M should apply the steps in the next paragraph to that place or places.

For each place, M looks in its database and finds all the URLs that are pointed to by mobile tags (e.g. QR codes) physically visible in or around that place. These tags are 2 dimensional bar codes. Here, ‘mobile’ refers to the mobility of a user with a cellphone that can decode these tags. Typically, most mobile tags are in fixed locations. The ‘around’ distance can be parameterized, and the parameter might be specified by Jane, with some default value used otherwise. Next, there are 2 possibilities. First, M downloads the pages from those URLs to itself, and it then downloads these to the Reader. Here, M might optionally wrap those into one file (e.g. a tar file, perhaps compressed), which the Reader can unwrap. Second, M downloads the list of URLs to the Reader, which then, or at some later time, when it is again in contact with the Internet, directly downloads the pages at those URLs.

By the end of the process of the previous paragraph, the Reader has downloaded the web pages for many mobile tags at and around a place that Jane will visit.

Note that the downloading is not restricted to just those web pages pointed to by mobile tags. A page might have links to other pages at that website, or to other websites. The downloading spider could use an open source program like wget, or modifications of such programs. A downloading parameter could be the maximum depth that links are followed, from each page at a given URL.

Later, suppose Jane is at one of those places, and the Reader has no wireless access to the Internet, or perhaps this access is at a very low bandwidth or is expensive. Jane sees a mobile tag posted on a wall, for example. She uses her cellphone, which has a camera, to scan the tag and decode it to a URL. The phone contacts the Reader. If the Reader has that page, it shows the page on its screen, or returns it to the cellphone, which displays it on its screen. There could be a default, settable by Jane, that defines that the page only appears on one device.

The mechanism of this section gets around one serious limitation of current mobile tags. Namely that using them in situ requires Internet access (usually wireless). It replaces the latter with the use of a Reader. Thus, the method gives incentive for the posting of mobile tags at remote locations, for example, where no Internet is accessible. But remember that the use of mobile tags is itself a means to an end. Typically, a mobile tag lets a user with a phone easily access data that someone has put on a website, where that data is often, but not necessarily, associated with the location where the tag was posted. So the method in turn aids the development and running of web sites associated with locations, by helping direct traffic to them. Even if this traffic is to the reading of web pages that have been stored offline from the web.

The method takes advantage of continuing trends of increasingly large and cheap storage. The Reader might download many web pages that are ultimately never read by the user. This is not a drawback of this invention, but a recognition of ongoing technology advances.

One extension of the above is where a Reader has a camera. Then, assuming that it has the required software to decode an image of a mobile tag, it can be used without a cellphone in the above steps.

Another extension is where the Reader is omitted. The cellphone is assumed to have enough memory so that it is used to contact M, and web pages are downloaded to and stored on the cellphone when it is in contact with the Internet.

M also needs further comment. It is a website that can map from an input location to mobile tag physically posted at or around that place. How is this information assembled?

It can be done by several non-exclusive ways. One is to accept input from people who presumably have been at that place, and recorded the mobile tags posted. At some later time, when they have Internet access, they post these to M, telling the place and the URLs. M might do some filtering to guard against the posting of spurious or inappropriate URLs. This could be manual or automated.

For example, M might have a blacklist of spam or pornographic or fraudulent websites, and reject any URL pointing to those domains.

Another method is where M accepts data via electronic messages (usually email) only from those domains mentioned in mobile tags. While the sender address of an email can be trivially spoofed, M can guard against this by sending a reply to that sender address, containing a link back to M's website that must be clicked on, as one of the steps before the submission is possibly accepted. The other filtering steps might be as for the previous 2 paragraphs.

Another issue is what other extra information might be stored on M other than (location, URL). Suppose M successfully accrues many URLs. It can be useful to know what topics or keywords could be associated with a URL or location. A topic might be one of {museum, restaurant, bar, zoo, etc}, for example. A URL could have several topics or keywords. This lets Jane and M apply some simple search criteria, so that Jane's Reader only gets URLs associated with some topics, for example, or URLs that are not in some topics.

Related to this is the idea of a mobile tag portal. Suppose at some location, various groups want to post their tags. Space could be restricted, and there might be perceptions of visual blight. One answer is for the tag of a mobile code portal to be posted, instead of several tags. Then, when the user goes to that URL, she sees a web page of links to the destinations of other websites.

Currently, the need for this seems not to have arisen, because most contemporary usages are where a place posts its mobile tag on its building, say. It can forbid others to put their tags there. But imagine another context, where there is a public place, for example, where several groups might want to post tags.

It can be seen that M can fulfill this role of a mobile tag portal. It can do this for many places. One trivial implementation is via the use of a URL notation like mobile.com/{place1/, place2/ . . . }, where place1, place2 etc refer to different locations.

Another aspect is to what accuracy is the location of a mobile tag known? For many usages, it might suffice to just describe a generic region around the location, like the name of the city it is in. But the location could also be posted down to meter accuracy, if known. This lets the use of applications on the user's device/s that can navigate to that location.

Hence M can satisfy to some extent one simple question about the proliferation of mobile tags. What mobile tags are in a given area? M is a central location on the Internet where this can be registered.

One advantage of this invention to the websites pointed to by mobile tags, assuming that the tags have a natural geographic association, is that for the websites to participate only requires conveying the locations and URLs to M. They do not need to change their pages, and they do not need to somehow emplace a wireless transceiver at a location that lacks Internet access, where this wireless device would likely need a wired connection to the Internet.

All of the above in this section has not needed the cellphone to have GPS. (Except possibly for the case where we discussed navigating to the precise location of a mobile code.) Now imagine that the cellphone has GPS. The section's method can be readily modified to handle the case where there are virtual tags for object hyperlinking, where the objects are places. A virtual tag is the association of a URL (and the page or data on that page) with a location, where this association happens on some website. There is no need for the physical posting of a mobile tag at the location.

Initially, when Jane's Reader has Internet access and goes to M's website, and posts her itinerary, Jane might also ask M to include websites or web pages pointed to by virtual tags. Where the tags are associated with the places in the itinerary. The method proceeds as earlier, storing those web pages on the Reader. One difference is that there is also a location stored. There might be a database on the Reader that can map from a location, or proximity to one, to the corresponding web pages. Then when Jane is at a place, her cellphone uses GPS to send coordinates to the Reader's application, which then searches for and can display any appropriate pages.

We claim:

1. The use of an electronic book reader (Reader) with a connection to a website (K), where the user uses the Reader to send a question with a possible set of answers, to K; where these are translated by K into target languages; where the choice of target languages is made by K, based on the location of the Reader and knowledge of the languages commonly spoken at the Reader's location; where the results are sent to the Reader as a displayable document; where the latter is shown by the user to another person presumed knowledgeable in a target language.

2. The method of claim 1, where the user sends K a travel itinerary, with questions and possible answers for several places in the itinerary; and K replies with displayable documents of translations in target languages based on the languages commonly used at those places; where the documents are grouped by place; where the replies are stored on the Reader.

3. The method of claim 1, where, if a machine translation to a target language is unavailable, a translation is made to another language linguistically close to the target language.

4. The method of claim 1, where, if a machine translation to a target language is unavailable, a translation is made to another language spoken at the Reader's location.

5. A method of a traveller presenting her itinerary to a website (K) before she travels; where K assembles digital data for places in the itinerary, including maps, timetables of buses and other public transport, and travel descriptions, including photos, and novels associated with the places; where the photos might have location and orientation information; where the data might come in part from independent sites on the Internet; where K downloads the data to the Reader as a customized travel guide, displayable on the Reader.

6. The method of claim 5, where the Reader uses any available information about its location to compare with the places in the itinerary; and if it is at or near a place in the latter, it rearranges the travel guide to make visible any data about its location.

7. The method of claim 6, where the Reader accesses GPS information from a nearby cellphone, where the latter has GPS access.

8. The method of claim 6, where at a location in the itinerary, the Reader shows a map of the positions where photos were taken; where the representations can show one or more of orientation, field of view and elevation; where the representations are selectable and show the photos and any associated text.

9. The method of claim 8, where the user can comment on or review a photo and associated text to the Reader; where the Reader can contact a website from which the photo was taken, to add the comment and an indicator that it was made at the location of the photo.

10. A method of a Reader and cellphone in communication with each other, where the cellphone has a camera; where a photo taken is automatically shown on the Reader's screen; where the user can store the image in the Reader and not in the cellphone's memory.

11. The method of claim 10, where the photo is not shown on the cellphone's screen.

12. The method of claim 10, where the Reader exports part of its storage to the cellphone, which uses that storage as local storage for reading and writing.

13. The method of claim 10, where the cellphone exports part of its storage to the Reader, which uses that storage as local storage for reading and writing.

14. The method of claim 10, where the keyboard on the Reader is used in place of the cellphone's keyboard.

15. The method of claim 10, where the screen on the cellphone, or subsets (windows) thereof, is exported to the Reader and shown on its screen.

16. The method of claim 10, where a two person interactive game is run on the cellphone and Reader, where the game is controlled from one or both devices, and where the game can take input from both devices.

17. A method of a website (M) assembling a list of locations of mobile tags, with the URLs pointed to by those tags; where a Reader presents M with a list of places; where M replies with the URLs and their pages associated with the places; where when the user is at a place with a mobile tag, she decodes it with her cellphone, which transmits the URL to the Reader, which displays the associated page.

18. The method of claim 17, where the user has GPS on her cellphone; where M has a list of virtual tags, mapping from the locations to the web pages for each tag; where these are sent to the Reader as per claim 17; where when she is at a location given by GPS, her phone contacts the Reader to display any web page associated with the location.
